(19) United States
(12) Patent Application Publication
(10) Pub. No.: US 2009/0047008 A1
(43) Pub. Date: Feb. 19, 2009

(54) Immersion Heater and Method of Use

(76) Inventor: James Straley, Holyoke, MA (US)

Correspondence Address: DOHERTY, WALLACE, PILLSBURY & MURPHY, P.C., ONE MONARCH PLACE, SUITE 1900, 1414 MAIN STREET, SPRINGFIELD, MA, 01144-1900, US

(21) Appl. No.: 12/189,988

(22) Filed: Aug. 12, 2008

Related U.S. Application Data
(60) Provisional application No. 60/955,444, filed on Aug. 13, 2007.

(30) Foreign Application Priority Data
Aug. 29, 2007 (CA) 2599746

(51) Int. Cl. H05B 3/80; F24H 1/20; H05B 3/04

(52) U.S. Cl. 392/498; 392/503; 219/523

(57) ABSTRACT

An immersion heater comprising temperature elevating components contained within a housing. The housing comprises a thermally conductive, electrically insulating epoxy on an upper portion thereof, and a highly thermally conductive epoxy on a lower portion thereof. The temperature elevating components comprise a heating element in communication with a heat regulating system comprising a thermostat, an electrically conductive bracket, and a thermal cut off fuse. The heating element comprises electrical resistant wire elements which are disposed in the lower portion of the housing and contained within a sheath. A temperature non-regulating portion of the thermostat, which is in communication with the electrically conductive bracket, is contained in the lower portion of the housing, and the temperature regulating component of the thermostat is contained in the upper portion of the housing.

### CROSS REFERENCE TO RELATED APPLICATIONS

This application claims the benefit of U.S. Provisional Application No. 60/955,444 filed on Aug. 13, 2007.

### BACKGROUND OF THE INVENTION

1. Field of the Invention

The present invention relates to an electric heater for fluids. More particularly, the present invention relates to a device for heating water in livestock watering tanks and in other containers, and to the device's method of use.

2. Background

Livestock require large amounts of water throughout the year. To provide livestock with needed water during the winter months, exterior livestock watering tanks are seasonally equipped with electric water heaters to prevent the water contained therein from icing over during temperatures below freezing, i.e., below 32 degrees Fahrenheit (“° F.”).

Electric water heaters for livestock watering tanks fall into two categories; submerged and floating. In both categories of water heaters, some method for temperature monitoring and regulation is provided. Temperature monitoring and regulation is necessary to address three problems: (1) the need to cut off power to the heating element when the device is dislocated from the water trough (safety); (2) the need to prevent unnecessary heating in mild temperatures; and (3) the need to provide maximum access to the water at low temperature extremes.

Brodie (U.S. Pat. No. 2,430,272) discloses a portable floating livestock water heater which does not address the safety problem. In Brodie, temperature monitoring and regulation is achieved by means of a bimetallic thermostatic bar for operating a thermostatic switch which controls the power to the heating element. Brodie's metallic bar is located in a position of “maximum response to changes in outside ambient air temperature and to the sun's radiant heat” and has essentially no response to the temperature of the heating element (See Column 3, lines 13-16). Thus, the Brodie device, when displaced from the trough as by an animal, would not cut off power to the heating elements until the ambient air was sufficiently hot—possibly as a result of a straw or grass fire.

Temple (U.S. Pat. No. 2,472,178) discloses a portable floating device which responds to the temperature of the water. However, the Temple device provides only minimum access to the water at low temperatures. In Temple, the thermostatic switch monitors the water-temperature immediately below the device and is set to open at “a temperature only . . . slightly above the freezing temperature of water.” (Column 2, lines 10-14). According to Temple, the apparatus acts to maintain the surface of the water against freezing “over an area encompassed by and extending slightly beyond the periphery of the heating element but will permit the water to freeze over the remainder of the surface”. (Column 2, lines 15-20). Temple further discloses that in cold weather, the unfrozen area around the device is so small that the animal, which wishes to drink, is required to press its nose against the device, submerging it, so as to gain access to the unfrozen area. Thus, the Temple device, which only permits one animal at a time to drink, is unsuited for use with large herds of livestock.

Langenbahn (U.S. Pat. No. 2,511,721) discloses a self filling stock tank having a non-portable heating device which is an integral part of the tank itself. In Langenbahn, the temperature of the water is monitored indirectly by a thermostat located in an air enclosed chamber immediately above the water wherein the temperature of the air in the chamber is dependent upon the temperature of the water which is immediately below it.

Landgraf (U.S. Pat. No. 2,576,688) discloses a portable tank mounted livestock water heater which addresses both the safety problem and the problem of unnecessary heating in mild temperatures, but the problem of providing maximum access to the water at low temperature extremes.

In Landgraf, the first two problems are solved by monitoring the temperature of the heating coil, as buffered by the water temperature, rather than the air or water alone. Specifically, the heating coil temperature is monitored by means of a submerged air capsule positioned between two legs of the heating coil, wherein two submerged metal plates provided contact between both legs of the heating coil and said capsule. Operationally, as the heating coil heats up, heat from the coil is transferred through the conductive metal plates and water to the capsule, causing the air in the capsule to expand driving a bellows and a plunger. Movement of the plunger past a thermostatically pre-set point automatically cuts off power to the heating coils.

Thus, in Landgraf, the power to the heating coil is cut off when the water is no longer able to dissipate the heat transferred from the heating coils to the air capsule, as when the water temperature locally attains the set temperature, or when the device is displaced from the water and substantially undissipated heat is transferred directly from the heating coil to the air capsule by the conductive metal plates.

Despite its improvements over the prior art, the Landgraf device was only suited to maintaining “an unfrozen opening in the vicinity of the heater large enough for drinking purposes.” (Column 1, lines 11-13). Consequently, the Landgraf device failed to provide a solution to the third problem discussed above: simultaneous access to the water within the tank by a plurality of animals by preventing a substantial area of the tank's surface from freezing.

McKinstry (U.S. Pat. No. 4,068,116) discloses a portable electric water heater having an improvement over the Landgraf device. The McKinstry device eliminates the air capsule, the bellows, and the moving plunger, and runs a “temperature sensing band” (conductive metal strip) from the submerged heating coil directly to a thermal fuse and thermostat. In McKinstry, the heat from the submerged heating coil, which is conducted towards the thermostat by the single conductive metal strip, is dissipated somewhat by the adjacent water. However, like Landgraf, McKinstry does not address the need to provide simultaneous access to the water by a plurality of animals.

Ward (U.S. Pat. No. 4,599,973) is primarily concerned with improving the safety of portable water heaters as disclosed by McKinstry and Landgraf. In particular, Ward (U.S. Pat. No. 4,599,973) recognizes the problem in McKinstry of poor connections between the heating coil and the conductive metal strip, and further recognizes that the problem would only worsen with oxidation or corrosion of the metal surfaces. Ward also prefers to reduce the watt density of the heater as to prevent accidental fires and burns to the livestock (Column 2, lines 10-16), and to have a device that is more directly responsive to the temperature of the heating element (Column 1, lines 61-66), and less responsive to the temperature of the water as Ward suggests the McKinstry (Column 1, lines 55-57) and Landgraf (Column 1, lines 67-68 and Column 2, lines 1-6) devices are.

Ward's solution is to provide the bottom of its floating device with a heavy duty molded platen-like aluminum housing, having a steel jacketed heating element molded within said housing along its circumference, and having a thermostat bonded to said housing on its inside (upper) surface. In this way, Ward reduced the watt density of the heating element by utilizing the greater surface area of the aluminum housing to dissipate the heat to the water.

However, because Ward is primarily concerned with the problem of safety, Ward does not address the problem of providing maximum access to the water during periods of extreme cold.

Moreover, none of the prior art designs disclose or even suggest a design for a portable electric water heater, which is safe even when mishandled, which prevents unnecessary heating in mild temperatures, and which provides maximum access to water at low temperature extremes.

Furthermore, the prior art immersion heaters comprise aluminum cast heaters, wherein the aluminum corrodes when immersed in water, even for short periods of time. This corrosion leads to a build up on the surface of the heater that limits the transfer of heat to the surrounding water, causing the heat to be retained and transferred to the thermostat. The increased temperature is sensed by the thermostat which shuts down prematurely, thereby allowing the water to freeze.

### SUMMARY OF THE INVENTION

The above problems and difficulties are alleviated by an immersion heater comprising temperature generating components and temperature sensing and regulating components contained within a housing. The housing comprises a thermally conductive, electrically insulating epoxy on an upper portion, and a highly thermally conductive epoxy on a lower portion. The heater further comprises a heating element in communication with a heat sensing and regulating system comprising a thermostat, an electrically conductive bracket, a thermal cut off fuse, and a plurality of electrical leads, cold pins, and insulating sheaths and/or insulating tubes. The thermostat is contained within both the upper and lower portions of the housing, the thermal cut off fuse is contained at least within the upper portion of the housing, and may also be disposed, at least in part, in the lower portion of the housing, and the active portion of the heating element and the electrically conductive bracket are contained within the lower portion of the housing.

The immersion heater disclosed herein is particularly advantageous in that the highly thermally conductive epoxy does not corrode as does the aluminum which is typically cast around the housing of prior art immersion heaters. This lack of corrosion greatly reduces or eliminates the possibility that the temperature build up within the immersion heater will trigger the thermostat to prematurely shut off the immersion heater.

Furthermore, the placement of the thermal cut off fuse and the thermostat within the inventive heating element allows for proper and efficient operation of the thermostat and the thermal cut off fuse, and more particularly, provides a sufficient amount of time to pass once a predetermined temperature has been detected by the thermal cut off fuse before the thermal cut off fuse overrides the thermostat and shuts off the heater.

Via a bracket, which is composed of thermally conductive materials and which is specially designed and positioned within the heater, the heater also provides an efficient way of diverting the heat generated from the heating element so that a more accurate reading of the temperature of the surrounding fluid may be obtained.

Other objects and advantages of the present invention will become obvious to persons of ordinary skill in the art, and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is a schematic depicting a front interior view of an exemplary immersion heater;

FIG. 2 is a schematic depicting a profile interior view of the immersion heater depicted in FIG. 1; and

FIG. 3 is a schematic depicting a top view of an exemplary bracket;

FIG. 4 is a schematic depicting a side view of the bracket depicted in FIG. 3;

FIG. 5 is a schematic depicting a front side of a grip of the bracket depicted in FIGS. 3 and 4;

FIG. 6 is a schematic depicting a view of section A-A of FIG. 4; and

FIG. 7 is a schematic depicting the bracket depicted in FIGS. 3-6.

### DETAILED DESCRIPTION OF THE INVENTION

In accordance with the invention, there is provided an immersion heater for use in heating fluids, particularly, but not exclusively, water, by immersion therein. The present inventive immersion heater comprises a housing which contains temperature generating and/or regulating components which include a heating element in communication with a heat sensing and regulating system.

The housing comprises a thermally conductive, electrically insulating epoxy on an upper portion, and a highly thermally conductive epoxy on a lower portion. In an exemplary embodiment, the thermally conductive, electrically insulating epoxy comprises a dielectric strength of about 450 volts/mil, a thermal conductivity of about 8.0 British thermal units per foot-hour-° F. per inch (“BTU/ft-hr-° F./in”), and is resistant to moisture absorption. The highly thermally conductive epoxy, i.e., an epoxy that comprises a thermal conductivity of greater than or equal to about 31.5 BTU/ft-hr-° F./in, is electrically conductive, and, hence, unlike the epoxy contained in the upper portion of the housing, it does not have a significant dielectric strength, i.e., the dielectric strength is preferably less than about 450 volts/mil.

In an exemplary embodiment, the thermally conductive/electrically insulating epoxy is black in color, and, in a particularly preferred embodiment, comprises Bisphenol A/Epichlorohydrin, N-Butyl Glycidal Ether, and an aluminum filler. The epoxy may further comprise a hardener such as, for example, a polyamide resin.

In an exemplary embodiment, the highly thermally conductive epoxy is gray in color, and, in a particularly preferred embodiment, comprises Bisphenol A/Epichlorohydrin, N-Butyl Glycidal Ether, and an alumina filler. The epoxy may further comprise a hardener such as, for example, a polyamide resin.

The heating element of the inventive immersion heater may comprise a sheath enclosing one or more electrical resistant elements. The sheath is formed to a contour according to the type of container in which it is to be inserted. In an exemplary embodiment, the sheath comprises an elongated U-structure, and encloses an electrical resistant element in the form of a wire embedded within a layer of insulating material. In an exemplary embodiment, the sheath comprises stainless steel, but may also comprise at least one of incoloy, aluminum, and the like, for example. Additionally, in an exemplary embodiment, the insulating material may comprise at least one of magnesia and alumina, and/or may include one or more heat shrink tubes, wherein an exemplary heat shrink tube may be selected from those conventionally found, and which may include, for example, a thermoplastic material, such as, Viton®, a silicone elastomer, polyolefin, a fluoropolymer (such as, FEP, PTFE, or Kynar), PVC, and neoprene.

The heating element may alternatively comprise a hollow metallic body in the form of a tube or a flat hollow plate-like body through which a heated fluid or steam is passed.

Additionally, to inhibit the deposition of scale from the heated liquid onto the heating element, the sheath may be coated with a coating of an inert plastics material having significant mechanical strength and stability at temperatures to which the elements may be raised during operation, wherein such temperatures are generally in excess of about 212° F. Examples of such inert plastics material include without limitation, at least one of poly ether ether ketone, poly ether sulphone, poly sulphone, polyamide, polyamide-amide, polyester, aramid, silicone, and the like. Some or all of these materials may be loaded with reinforcement such as minerals, for example, glass fibers or carbon fibers, to enhance their performance. Bonding agents may also be included to improve adhesion.

The heat sensing and regulating system of the inventive immersion heater comprises a thermostat in electrical communication with a thermal cut off (“TCO”) fuse. The thermostat turns the heating element on and off depending on ambient water temperature, while the TCO fuse functions as a thermal fuse for safety. Accordingly, the TCO fuse turns the heating element off in the event the thermostat fails to properly regulate the temperature of the surrounding fluid. As this is preferably a one shot function, if the TCO fuse trips, the heating element will no longer generate heat.

The actions and interactions of the thermostat and the TCO fuse are critical to the proper function and safety of the heating element, particularly under abnormal operating conditions, such as when the immersible heater is powered in air. That is, the thermostat must shut off quickly in response to the TCO fuse, while the TCO fuse has to function just beyond the anticipated time range it will take the thermostat to respond, and must also be able to shut off the heating element in the event of a thermostat failure. To achieve this end, the TCO fuse is preferably embedded within the sheath of the heating element such that the TCO fuse is at last partially, and more preferably primarily, contained within the upper portion of the housing which comprises the thermally conductive, electrically insulating epoxy, and the TCO fuse is contained within an insulating assembly which both insulates the TCO fuse and also allows for the ready transfer of heat to the thermostat.

In addition to the unique placement of the TCO fuse within the housing, another unique feature of the immersion heater is that a base of the thermostat is encased in the highly thermally conductive epoxy containing portion of the housing, i.e., the lower portion of the housing, thereby, allowing the thermostat to accurately “read” the temperature of the fluid, while an upper portion of the thermostat, i.e., the portion of the thermostat that contains the electrical terminals, is encased in the thermally conductive, electrically insulating epoxy containing portion of the housing, i.e., the upper portion of the housing.

The heat generating and regulating system further comprises a thermal conductive bracket which is uniquely designed and positioned to transfer heat quickly from the heating element, wherein a quick transfer of heat is particularly preferred in the event the heating element is powered in air. That is, in an exemplary embodiment, the bracket is designed and positioned to efficiently transfer heat from the heating element to the thermostat so that the thermostat will turn the heater off and/or on in less than about 3.5 minutes. The bracket comprises one ore more thermally conductive materials, wherein a particularly preferred thermally conductive material is aluminum.

Additionally, in an exemplary embodiment, a portion or all of the bracket is covered by a thin layer of epoxy to facilitate improved sensing of the ambient fluid temperature, wherein the epoxy preferably comprises the highly thermally conductive epoxy discussed above in relation to the lower portion of the housing. As will be discussed below, in an exemplary embodiment, the bracket is positioned close to the heating element so that the bracket can readily transfer the heat from the heating element to the thermostat; additionally, the bracket is positioned in the highly thermally conductive epoxy portion of the housing so that, by this position the bracket can more readily sense the temperature of the fluid in which the immersion heater is immersed.

As stated previously, the use of the bracket is unique to the invention. The uniqueness includes the placement of the bracket so that it can quickly pick up heat from the “hot” section of the heating element and transfer the heat to the thermostat to shut down the immersion heater in the event the immersion heater is powered in air. Disposition of only a thin layer, i.e., less than about 0.094 inch, of epoxy on the bracket allows the thermostat to accurately read the temperature of the fluid when the immersion heater is properly immersed, as the heat from the heating element is not transferred to the thermostat, a situation which would cause a premature shut down of the immersion heater. In addition to coating the bracket with a highly thermally conductive epoxy, the design of the bracket further allows the thermostat to sense the temperature of the surrounding fluid and not the temperature of the heating element by deflecting from the temperature regulating portion of the thermostat the heat generated from the heating element to a temperature non-regulating region of the thermostat.

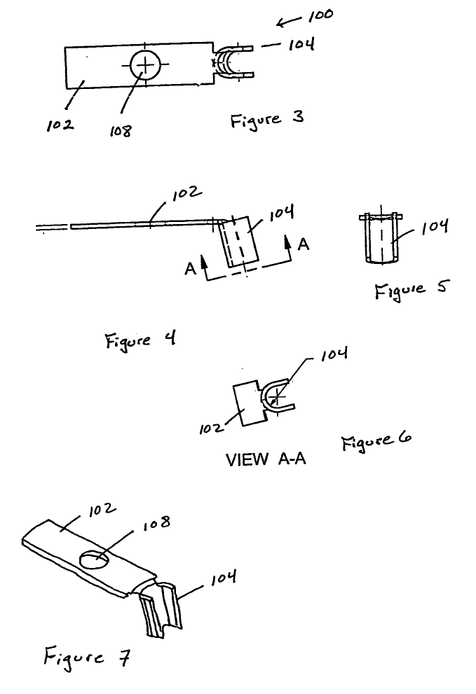

An exemplary bracket is depicted in FIGS. 3-7. Referring to these figures, an exemplary bracket 100 comprises a plate 102 laterally extending from a grip 104. Grip 104 is semi-cylindrical in shape and is structured to fit onto an exterior surface of the heating element. Plate 102 comprises a hole 108 centrally positioned on a body of plate 102. Hole 108 allows air to be vented out of the highly thermally conductive epoxy during the heater's manufacturing process. Furthermore, hole 108 affects the amount of heat and the speed at which the heat is transferred from bracket 100 to the temperature non-regulating portion of the thermostat, as the hole is the result of removing conductive material.

In addition to the thermostat, the TCO fuse, and the bracket, the heat sensing and regulating system further comprises a plurality of cold pins, insulating tubings, and a power cord all of which will be described below.

The invention will now be described with reference to the figures, however, the invention is not to be construed as limited to the figures, but includes all natural variations and modifications thereto.

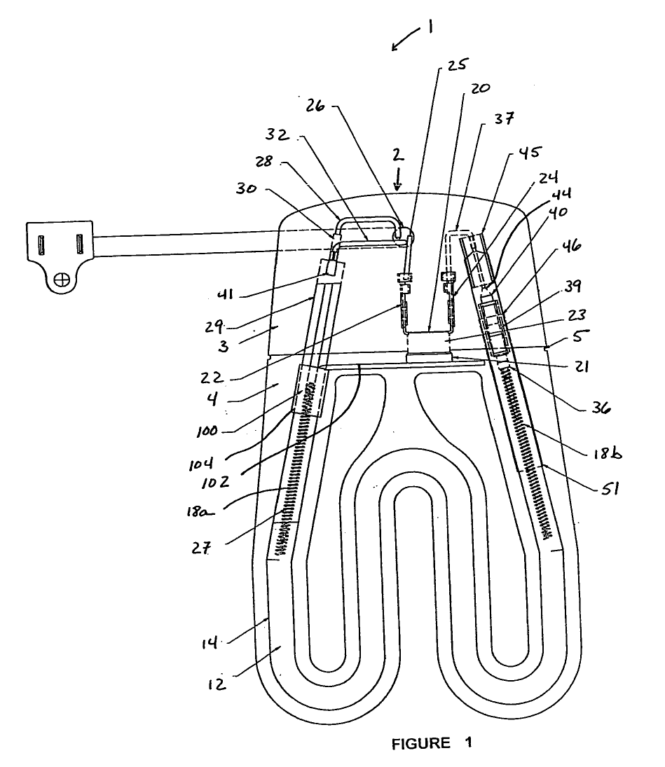

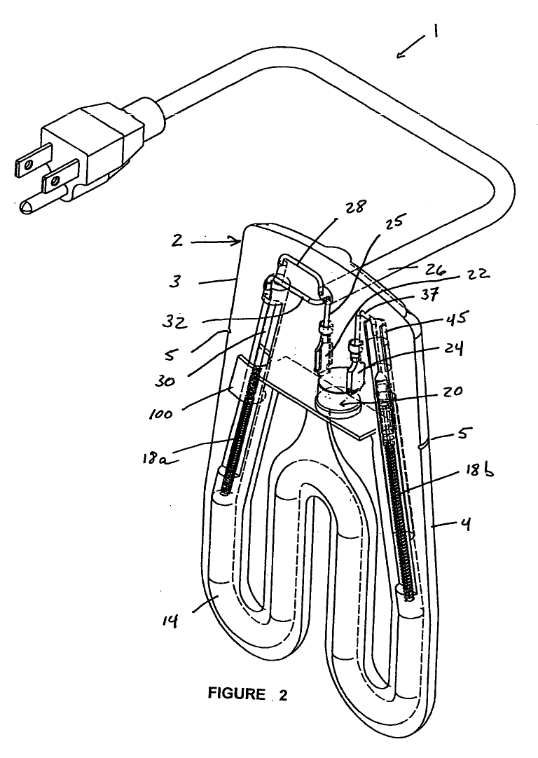

Referring to FIGS. 1 and 2, an exemplary immersion heater 1 comprises a housing 2. Housing 2 comprises a thermally conductive, electrically insulating epoxy on an upper portion 3, and a highly thermally conductive epoxy on a lower portion 4, wherein the demarcation between portions 3 and 4 is located at boundary 5.

Immersion heater 1 further comprises a heating element 12 comprising a tubular sheath 14, which, in an exemplary embodiment may comprise, for example, at least one of copper, brass, stainless steel, and the like. Tubular sheath 14 passes through both portions 3 and 4 of the housing.

Heating element 12 further comprises electrical resistance wire elements 18a and 18b contained within tubular sheath 14, and which may be enveloped within sheath 14 by a layer of insulating material, e.g. magnesia, alumina, and the like (not shown). Electrical resistance wire elements 18a and 18b are wholly or largely contained within lower portion 4 of housing 2.

A heat regulating system comprises a thermostat 20 comprising a base 21 physically connected to an upper portion 23, wherein base 21 is a temperature non-regulating portion of thermostat 20 and upper portion 23 is the temperature regulating portion of the thermostat. Base 21 is disposed wholly or primarily within lower portion 4 of housing 2, and upper portion 23 is disposed wholly or primarily within upper portion 3 of housing 2. Thermostat 20 further comprises electrical terminals 22 and 24 which are located in upper portion 3 of the housing on upper portion 23 of thermostat 20. Extending from electrical terminal 22 is a hot lead 25 which leads to a power cord 26. A neutral lead 28 connects power cord 26 to a cold pin 30, and a ground wire 32 connects power cord 26 to tubular sheath 14 via a ground tab 41 which is welded to tubular sheath 14. Cold pin 30, which extends from upper portion 3 to lower portion 4, is physically connected to electrical resistance wire element 18a.

Grip 104 of electrically conductive bracket 100 grips an outer surface of tubular sheath 14 such that plate 102 of bracket 100 is in physical communication with base 21 of thermostat 20. Bracket 100 is contained entirely within lower portion 4 of the housing.

Extending from a terminal end of cold pin 30 is an active portion 27 or “hot section” of heating element 12, wherein active portion 27 of heating element 12 runs into lower portion 4 of the housing, while, a non-active portion 29 of heating element 12 extends into upper portion 3 of the housing. More particularly, active portion 27 runs from an end of cold pin 30 to a shoulder of a tapered cold pin 36.

Tapered cold pin 36 of immersion heater 1 is inserted through a second, opposite end of tubular sheath 14 and extends into upper portion 3 of the housing at one end, and extends into lower portion 4 of the housing at an opposite end. Electrical resistant element 18b is connected to and extends from an end of cold pin 36. An insulating tube 51, such as a Viton® shrink tubing, is heat shrunk around sheath 14 in the region of cold pin 36 and electrical resistant wire element 18b.

Immersion heater 1 further comprises a TCO fuse 40 which is encased within tubular sheath 14. An end of TCO fuse 40, is connected to tapered cold pin 36 via a silver plated, copper connecting sheath 39 which contains a portion of TCO fuse 40. A silicone insulating tubing 46 is heat shrunk around sheath 39. Importantly, TCO fuse 40 is contained within upper portion 3 of the housing, and is electrically isolated from heating element 12 by situating it within insulating tubing 46. Extending from an end 44 of TCO fuse 40 is TCO fuse lead 37 which terminates at terminal 24 of thermostat 20. An electrically insulating, silicone tube 45 is inserted into sheath 14 around a portion of TCO fuse lead 47, thereby insulating TCO fuse lead 47 from sheath 14.

The invention further comprises a method of using the inventive immersion heater disclosed herein. Referring to the figures, an exemplary method for heating a fluid source, and in particular, water contained in a livestock watering bin, comprises disposing housing 2 in the fluid source and plugging power cord 26 into an appropriate electrical outlet.

The method further comprises providing housing 2 comprising thermally conductive, electrically insulating upper portion 3 and highly thermally conductive lower portion 4. In an exemplary embodiment, upper portion 3 comprises a dielectric strength of at least about 450 volts/mil and a thermal conductivity of about 8 BTU/ft-hr-° F./in, and lower portion 4 comprises a dielectric strength of up to about 450 volts/mil and a thermal conductivity of at least about 30 BTU/ft-hr-° F./in.

The method further comprises providing heating element 12 and a heat sensing and regulating system, wherein heating element 12 generates thermal heat in response to the heat sensing and regulating system. Providing of heating element 12 comprises disposing electrical resistant wire elements 18a and 18b within sheath 14, wherein sheath 14 is disposed within both upper portion 3 and lower portion 4 of housing 2, and wherein electrical resistant wire elements 18a and 18b are contained within lower portion 4 of housing 2.

Providing of the heat sensing and regulating system comprises disposing heat transferring bracket 100 on sheath 14 in lower portion 4 of housing 2, disposing TCO fuse 40 within an insulating assembly in upper portion 3 of housing 2, and thermally connecting thermostat 20 with TCO fuse 40 and with heat transferring bracket 100.

Disposing TCO fuse 40 within an insulating assembly comprises heat shrinking an insulating tubing around sheath 14, and applying insulating tubing 46 and silver plated, copper connecting sheath 39 around TCO fuse 40.

Thermally connecting thermostat 20 with TCO fuse 40 comprises connecting TCO fuse lead 37 from TCO fuse 40 to electrical terminal 24 of thermostat 20 and further insulating TCO fuse lead 37 with silicone dielectric tubing 45. Thermally connecting thermostat 20 with heat transferring bracket 100 comprises placing plate 102 of bracket 100 on a surface of base 21 of thermostat 20, wherein base 21 of thermostat 20 is located in lower portion 4 of housing 2.

By assembling and utilizing immersion heater 1 according to the method disclosed herein, one assures that the TCO fuse will respond at an appropriate time and in an appropriate manner; that the heat from the fluid will reach the thermostat in a relatively quick and accurate fashion, thereby providing for an accurate reading of the fluid's temperature; and inhibiting corrosion of the housing.

With respect to the above description, it is to be realized that the optimum relationships for the parts of the invention, which include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

It is further noted that although the immersion heater has been described as particularly useful in livestock watering bins, it is not limited to such a function. Rather, the heater may be used in a wide variety of applications, including, for example, in refrigerator coils and drain pans, whereby the heater can be placed within the drain pan to facilitate evaporation and to avoid rust and freezing of the water in the drain pan, in goldfish ponds, bird feeders, biodiesel heaters, diesel fuel heaters, fuel oil heaters, and the like.

What is claimed is:

1. An immersion heater for measuring the temperature of a fluid, comprising:
a housing comprising a thermally conductive, electrically insulating epoxy on an upper portion thereof, and a highly thermally conductive epoxy on a lower portion thereof;
a heating element comprising an electrical resistant element disposed within a sheath, wherein the sheath extends into both the upper portion and the lower portion of the housing;
a thermostat disposed within the housing; and
a thermal cut off fuse in thermal communication with the electrical resistant element and the thermostat.

2. The immersion heater of claim 1, wherein the upper portion of the housing comprises a dielectric strength of at least about 450 volts/mil and a thermal conductivity of up to about 8 BTU/ft-hr-° F./in, and the lower portion comprises a dielectric strength of up to about 450 volts/mil and a thermal conductivity of at least about 30 BTU/ft-hr-° F./in.

3. The immersion heater of claim 2, wherein the upper portion comprises bisphenol A/epichlorohydrin, N-butyl glycidal ether, and aluminum, and wherein the lower portion comprises bisphenol A/epichlorohydrin, N-butyl glycidal ether, and alumina.

4. The immersion heater of claim 1, further comprising a thermal conductive bracket having a plate extending from a grip, wherein the grip envelops the sheath and the plate is disposed on a surface of the thermostat, and further wherein the plate is disposed within the lower portion of the housing.

5. The immersion heater of claim 4, wherein the bracket comprises a layer of a thermally conductive epoxy disposed on a surface of the bracket.

6. The immersion heater of claim 5, wherein the layer of epoxy comprises a thickness of up to about 0.100 inch.

7. The immersion heater of claim 5, wherein the thermostat comprises a temperature regulating portion and a temperature non-regulating portion, wherein the temperature regulating portion is disposed in the upper portion and the temperature non-regulating portion is disposed in the lower portion, and further wherein the plate of the bracket is disposed on a surface of the temperature non-regulating portion.

8. The immersion heater of claim 7, wherein the thermal cut off fuse comprises a thermal cut off fuse lead attached to a second electrical terminal of the thermostat, wherein a portion of the thermal cut off fuse lead is enveloped in a dielectric tubing, and the second electrical terminal is contained within the upper portion of the housing.

9. The immersion heater of claim 8, further comprising a first cold pin and a second cold pin, wherein the first cold pin and the second cold pin extend from the upper portion to the lower portion of the housing, and further wherein the electrical resistant element comprises:
a first electrical resistant wire connected to the first cold pin in the lower portion and extending from the first cold pin into the lower portion; and
a second electrical resistant wire connected to the second cold pin in the lower portion and extending from the second cold pin into the lower portion, and further wherein the thermal cut off fuse is contained within the second cold pin.

10. The immersion heater of claim 9, wherein the thermostat further comprises a first electrical terminal contained within the upper portion of the housing, wherein a hot lead is attached to the first electrical terminal, and further wherein a ground wire is connected to the hot lead and to the first cold pin, and further wherein a neutral lead is connected to the ground wire and to the first cold pin.

11. The immersion heater of claim 10, wherein the upper portion of the housing comprises a dielectric strength of at least about 450 volts/mil and a thermal conductivity of up to about 8 BTU/ft-hr-° F./in, and the lower portion comprises a dielectric strength of up to about 450 volts/mil and a thermal conductivity of at least about 30 BTU/ft-hr-° F./in.

12. A method for heating a fluid, wherein the method comprises:
providing a housing comprising a thermally conductive, electrically insulating upper portion and a highly thermally conductive lower portion;
providing a heating element contained within the housing; and
providing a heat sensing and regulating system contained within the housing, wherein the heating element generates heat in response to the heat sensing and regulating system.

13. The method of claim 12, wherein the upper portion comprises a dielectric strength of at least about 450 volts/mil and a thermal conductivity of up to about 8 BTU/ft-hr-° F./in, and the lower portion 4 comprises a dielectric strength of up to about 450 volts/mil and a thermal conductivity of at least about 30 BTU/ft-hr-° F./in.

14. The method of claim 13, wherein the providing of the heating element comprises disposing an electrical resistant element within a sheath, wherein the sheath is disposed within both the upper portion and the lower portion of the housing, and the electrical resistant element is contained entirely within the lower portion of the housing.

15. The method of claim 14, wherein providing the heat sensing and regulating system comprises:
providing a thermostat;
disposing a heat transferring bracket on a portion of the sheath contained in the lower portion of housing 2;
containing at least a portion of a thermal cut off fuse within an insulating assembly;
disposing the thermal cut off fuse contained within the insulating assembly into a portion of the sheath contained in the upper portion of the housing; and
connecting the thermostat with the thermal cut off fuse and with the heat transferring bracket.

16. The method of claim 15, wherein providing the thermostat comprises disposing a temperature sensing portion of the thermostat within the upper portion of the housing and disposing a temperature non-sensing portion of the thermostat within the lower portion of the housing, and further wherein connecting the thermostat with the heat transferring bracket comprises placement of a portion of the heat transferring bracket onto a surface of the temperature non-sensing portion of the thermostat.

17. The method of claim 16, wherein containing at least a portion of the thermal cut off fuse within the insulating assembly comprises applying insulating tubing and a silver plated, copper connecting sheath around at least a portion of the thermal cut off fuse.

18. The method of claim 16, wherein connecting the thermostat to the thermal cut off fuse comprises:
attaching a thermal cut off fuse lead of the thermal cut off fuse to an electrical terminal of the thermostat; and
disposing a dielectric tubing around the thermal cut off fuse lead.

19. The method of claim 13, further comprising immersing the housing into a liquid source.
